(19) United States
(12) Patent Application Publication
(10) Pub. No.: US 2001/0027557 A1
(43) Pub. Date: Oct. 4, 2001

(54) Search system, receiving apparatus and search apparatus for use thereof, and search method thereof

(76) Inventors: Keirou Shinkawa, Tokyo (JP); Teruhiro Takezawa, Tokyo (JP); Shuichi Tago, Tokyo (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/766,298

(22) Filed: Jan. 19, 2001

(30) Foreign Application Priority Data
Feb. 21, 2000 (JP) 2000-048896

(51) Int. Cl. H04N 7/16

(52) U.S. Cl. 725/1

(57) ABSTRACT

For providing a device for serving search/report to viewers responding to an inquiry from the viewers, about information relating to EPGs of the BS digital broadcasting and contents of the data broadcasting services, all channels of the EPGs information of the BS digital broadcasting and the content information of the data broadcasting are received, so as to establish a data base thereof, and at the same time a key-word search data base is also established, thereby supplying a EPG service and a search service, etc., responding to a request for information supply from the viewer.

### BACKGROUND OF THE INVENTION

The present invention relates to a search system for conducting search on information of program guide and/or program content for digital broadcasting, in particular on unique information of the program guide and/or program content for a BS digital broadcasting, upon basis of a search request from a user, thereby providing the information searched to her/him, and in particular, relates to a receiving apparatus and a search apparatus for use thereof, and further to a search method therefor. However, the information of program guide and/or program content herein means the program guide information (it is abbreviated by EPG, hereinafter, in a meaning of Electric Program Guide) and/or the information of data broadcasting (for example, character information and/or picture information) in the digital broadcasting, mainly.

A method for providing the EPG in the CS (Communication Satellite) digital broadcasting, which is now available, is to transmit the EPG through a channel CH for exclusive use thereof, together.

Also, a method for providing the data broadcasting in the CS digital broadcasting is to use a data format for communication with provision of the data channel CH for exclusive use thereof, thereby using a down-circuit which is higher in speed than a telephone circuit.

### SUMMARY OF THE INVENTION

Comparing to the CS digital broadcasting mentioned above, studies are made upon a BS digital broadcasting that will be started in 2000.

With the BS digital broadcasting, in addition to the service of broadcasting 7 channels (CHs) of the digital programs of high definition TV (i.e., digital HDTVS), or 24 CHs of the digital programs of normal TV in place thereof, it is planned to provide a data broadcasting service of supplying information relating to the TV programs and independent data information which does not relate to the TV programs. Those broadcasting services will be provided through the respective CHs for exclusive use thereof, which are occupied by a plural number of broadcasting or TV stations, and the each TV station provides it's own broadcasting service. For those broadcasting services, in particular about the broadcasting programs, the EPG is provided for the purpose of assistance of the viewer in the selection of TV programs. This EPG can be divided into an EPG for all TV stations, which guides all the TV programs of the BS broadcastings, as a whole, and an EPG for each TV station, for introducing the programs by it's own. The EPG for all TV stations is supplied through eight (8) carriers from the satellites; therefore, addressees (or subscribers) can obtain the EPG for all TV stations so as to know the available programs on the BS digital broadcasting, even if they receive any CH of them. However, for the viewers who receive the EPG for each TV station, they can know only the programs which are independently provided by the each of the broadcasting stations. The method for providing this EPG is completely different from that of the EPG for the CS digital broadcasting programs, which is transmitted together through the CH for exclusive use thereof, collectively.

Further, with the data broadcasting service of the BS digital broadcast, a plural number of undertakers of the data broadcasting services at each station provide a large number of services, such as shopping, etc., in the format of BML or XML. This is transmitted together with the mixture of a video packet and an audio packet, being inserted into the data packet of a transmission format of the BS digital broadcasting, therefore only the data of the CH that is received can be taken or read in. According to the data broadcasting of the CS digital broadcast, the data CH is provided for the exclusive use thereof, and a data format for communication is used therein, thereby providing a down-circuit which is higher in the speed comparing to that of the telephone circuit, and this is completely different from the present BS data broadcast, which provides a new service by means of picture information, etc., for exclusive use thereof. The present BS data broadcasting looks to be similar to the data broadcasting which is inserted into the vertical retracing interval in the analogue broadcasting, however the data of the BS data broadcasting comes up to 1.5 Mbps-40 Mbps, i.e., the data service of high speed and a large data amount, as about 100 times large as the small amount of data, 30 kbps-40 kbps, in the data broadcast of the analogue broadcasting. With the data screen, it is a service of using the BML or XML which can perform the high definition display, comparing to the HTML that is used in the Internet very often.

Namely, the subscriber can receive the data broadcasting services to view them, which are supplied to that station, as well as, the EPG for all TV stations and the EPG for each TV station of that station, other than the TV programs on the selected CH, however cannot obtain the EPGs for each TV station of other stations and the contents of the data broadcasting services thereof, unless the receiving CH is changed to.

Also, the present service is a kind of the broadcasting, which serves a large amount of data from the satellite to a large number of homes in one direction cheaply, in a real-time manner, therefore almost of the services are temporary in the nature, i.e., they pass by and distinguish away. This is an aspect being different from the Internet, with which the service information can be viewed by a viewer through the telephone circuit at any time when she/he wishes.

Then, if a memory apparatus of a large capacity is provided in the receiver, so as to scan all the CHs received and memorize the contents of the information of the EPG for all TV stations and the data broadcasting, it is possible to see all of the service contents. However, if scanning is made on the CHs of the receiver continuously, for the purpose of storing the information transmitted from the satellites, it is impossible to view the TV programs. However, even if the information could be stored by scanning the all CHs received during the receipt of the TV data, but only the data of the data broadcasting comes up to several thousands of pages, and then it takes a very long time only to see that data on the screen, therefore it is difficult. Also, by taking a fact into the consideration, that those contents are changed by a unit of one (1) day for the broadcasting services, it is difficult to deal with this, and it is also difficult to find out the information that the viewer wish to see, among such the large amount of the stored data. Further, even if trying to dissolve all of those problems, the receiver comes to be an apparatus, which necessitates complicated operation and expensive one, as a household electric appliance.

Then, a device and a business in a form of a search service center is effective, in which the viewers can be provided with a service of search and an answer (report) thereto, responding to an inquiry (i.e., on which channel and when it can be seen? etc.), which the viewer has about the information relating to the EPGs for the BS digital broadcasting and the contents of the data broadcasting services. In particular, the information mentioned above flows in real-time, unilaterally as the broadcasting services, therefore many information are overlooked. Accordingly, a service business is also effective, of providing or supplying information and materials to the viewers responding to the inquiry, relating to the information which have been broadcasted once. In this manner, with providing the search apparatus separate from the broadcasting stations and homes, it is sufficient for the household receiver to have only the minimal functions which are necessary for it, therefore it is possible to achieve a receiver of easy operation and low price, as well as, for the subscriber to see the broadcasting services at any time when she/he wishes.

As was mentioned in the above, according to the device and the business, in which a database is constructed by receiving the EPG information of the BS digital broadcasting and the content information of the data broadcastings for all of those CHs, and a keyword search database is constructed as well, a the same time, wherein the EPG service and/or the search service, etc., can be provided to the viewer responding to the request for the information, it is possible for the viewer to selectively view only what she/he wishes among the large amount of the broadcasting services, easily, by means of the receiver which is cheap and operable with ease, as well as, to view the information which she/he overlooked, therefore the viewers can enjoy comfortable environment of information, fully.

### BRIEF DESCRIPTION OF THE DRAWINGS

Those and other features, objects and advantages of the present invention will become more apparent from the following description when taken in conjunction with the accompanying drawings wherein:

FIG. 1 is a view for showing a device for a search service, according to the present invention;

FIG. 2 is a view for showing the structure of a search service center, according to the present invention;

FIG. 3 is a view for showing an example of a relationship between the search service center and an undertaker of the data broadcasting, according to the present invention;

FIG. 4 is also a view for showing an example of a relationship between the search service center and the undertaker of the data broadcasting, according to the present invention;

FIG. 5 is a view for showing flows of information and fees relating to the search service center, according to the present invention;

FIG. 6 is also a view for showing flows of the information and fees relating to the search service center, according to the present invention;

FIG. 7 is a view for showing other service by the search service center, according to the present invention;

FIG. 8 is a view for showing flows of the information and fees in the service shown in the FIG. 7;

FIG. 9 is a view for showing other device for a search service, according to the present invention;

FIG. 10 is also a view for showing a relationship between the search service center and an undertaker of CATV, according to the present invention; and

FIG. 11 is also a view for showing further other device for a search service, according to the present invention.

### DETAILED DESCRIPTION OF PREFERRED EMBODIMENTS

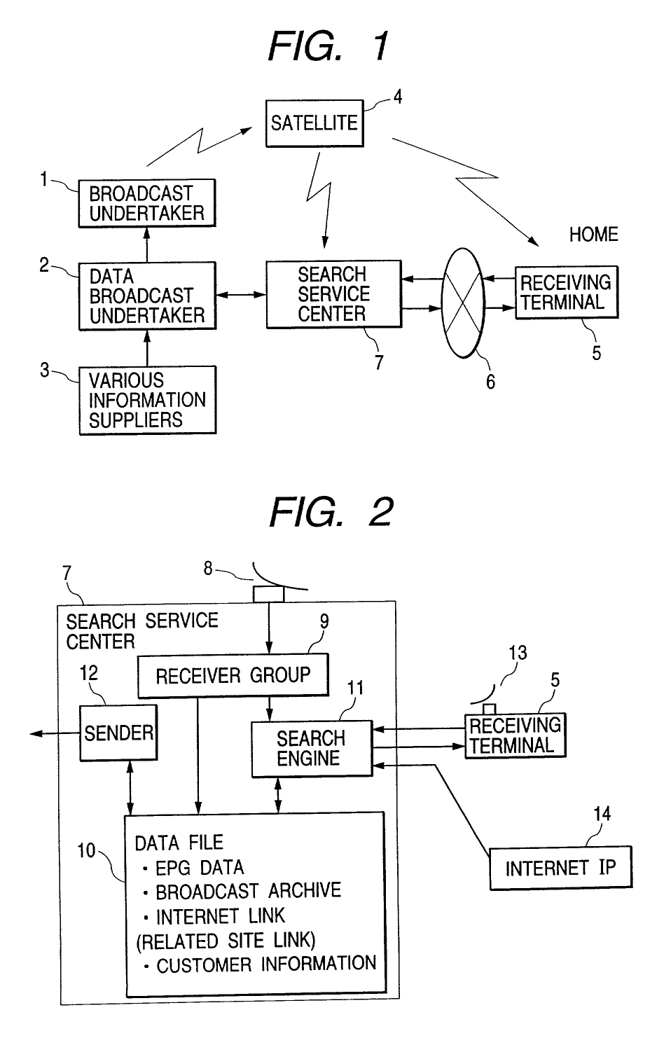

Hereinafter, embodiments according to the present invention will be fully explained by referring to the attached drawings. FIG. 1 shows an example of system as a device or mechanism for conducting a search service, according to the present invention, wherein an attention is paid on the EPG service and the data broadcasting service in the BS digital broadcasting. An undertaker 1 of the BS digital broadcasting sends out (or transmits) video and audio information of TV programs. Further, a plural number of the broadcast undertakers 2 collect the data broadcast contents transmitted from plural and various kinds of suppliers (or providers) 3 of information and the data broadcast contents which is produced by the undertaker itself, etc., and broadcast them through the broadcast undertaker 1 and a satellite 4. At the homes, this broadcast is received by means of a receiving terminal 5, such as, a PC (Personal Computer) equipped with a receiving function, a set-top box, or a TV apparatus building the receiving function therein, etc. Further, the receiving terminal 5 comprises a function of transmitting information in an upper-direction through a telephone circuit 6, for the purpose of dealing with the services of, such as, a join-in service in relation to the TV programs on the data broadcasting, and an independent shopping, etc., and with using this, also a search request upon information at the desire of a viewer is transmitted to the search service center 7. The search service center 7 sends out or transmits information on the broadcasting channels, etc., answering to the search request, through the telephone circuit 6 to the receiving terminal 5.

FIG. 2 explains the device or mechanism of the search service center 7 providing the search service, according to the present invention. In the service center 7, the EPG information and the content data of the data broadcastings on all the CHs of the respective broadcasting undertakers are received and obtained, by means of an antenna 8 and a group of receivers 9, and they are accumulated or stored in a data file 10. At the same time, from the EPG information and the content data of the data broadcasting, keywords are extracted by means of a search engine 11 and are stored in a database. Since the content data of data broadcasting are in the expression of the tag format of BML or XML, the keywords can be extracted in the same manner as the HTML of the Internet, i.e., prompt or immediate selection can be obtained by means of the search engine 11.

At home, when the viewer sends out (or transmits) the search request (for example, the keyword, etc.) for the information at her/his desire from the receiver terminal 5, among the unique EPG information of the CHs not selected and the content data of the data broadcasting, the request is entered into this search center through the telephone circuit or the communication circuit, and then a list of the information relating to the keyword is searched and extracted by the search engine 11 within the center, from the information accumulated or stored in the data file, so that the content searched and extracted is sent out (or transmit) to the receiving terminal 5 of that viewer through the telephone or communication circuit. With doing so, the viewer can obtains the information of, such as, a fact on which data channel that program is broadcasted at the present time, etc., with an aid of the information relating to the keyword, i.e., this enables the viewer to receive and view the program on that data channel. Further, even if the information relating to the keyword at her/his desire does not relate to the present one, but to the past one, it is possible to select or take out that information from the database, so as to be delivered through the telephone circuit 6. Depending upon an amount and/or contents of the request, the data broadcasting channel can be delivered from a sender (or transmitter) 12 to home through the broadcast station.

Further, by adding a screen for the search service into the data broadcasting, if it is possible to show a search screen on a display means, such as, a display apparatus in the receiver apparatus, so as to enable the viewer to conduct search operations on that search screen, a simple device can be built up for sending out the request to the search center and receiving the search result therefrom, thereby improving convenience when she/he uses the present service, greatly.

Also, the explanation was given on the present search service for broadcasting, in which the general telephone circuit 6 is used, however if the Internet is used as the circuit and a search database is provided for the information provider (supplier) on the Internet (i.e., Internet IP) within the search service center 7, it is possible to build up a device, in which the search service can be performed without barrier between the broadcasting and the Internet, so that the viewer can view them without the distinction between the broadcasting information and the Internet information. In this case, link information of the Internet is stored in the data file 10, together with a broadcasting archive, in which are arranged the EPG data for all stations, the EPG data for each station, the content data of data broadcasting and the search keyword, as well as, customer information, such as, a history of using the search by a search user.

With using such the present search service, it is not necessary to accumulate or store the large amount of data, while always scanning on the CHs by the receiver, and the viewer can see the information that she/he want, quickly on the receiving terminal, which is cheap in the price and can be operated easily.

However, there are cases where the transmission of the search request from the receiving terminal 5 can be done freely, and where it is possible but under a condition. The former means a case where the service to the user is free-charge; therefore it is possible to execute the search request immediately, while the latter is the case where the service is provided to the user at charge, therefore the search cannot be executed if any of the cost is paid for.

As an example of the latter, it can be considered to ask the user to file a predetermined application before conducting the search. Namely, it is so constructed that, the user must input the information relating to the user her/himself, who is operating, on a predetermined screen, while the search service center can start the search service to the user who is operating by receiving the said information. Here, as the information to be inputted in relation to the user, the followings can be listed up: an address, a name, an age, an occupation, a telephone number, a mail address, a card number of her/his credit card or an account number of a bank, a taste information in an answer to an attitude survey and/or a questionnaire survey, an approval to the start of service for making re-confirmation if she/he wishes to receive the present service at charge or not, or a consent to provide a history of viewing, which will be mentioned later. Also, with the acceptance and the start mentioned above, they may be conducted through the telephone line and/or the communication line.

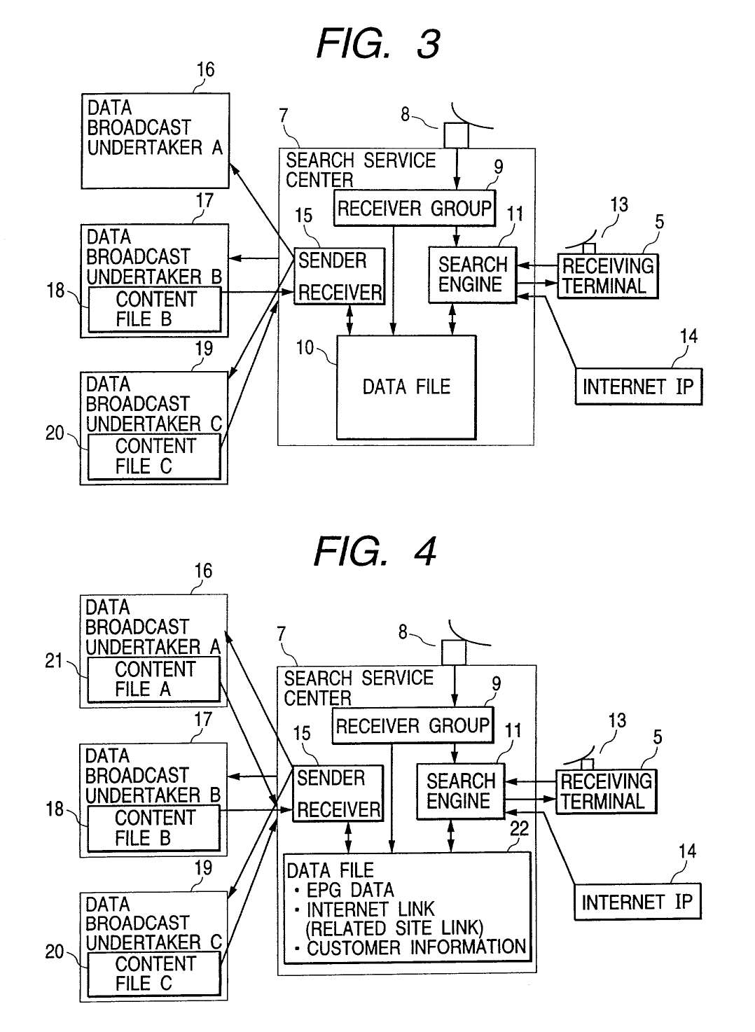

In addition to the basic service of answering the location of the information, for which the search request is made, by selecting it from all of the received information, the search service center 7 provides a service of supplying the broadcasting contents responding to the request. When the supply of the broadcasting contents is chargeable, since it concerns with the copy rights of the broadcasting undertaker and/or the information supplier, in relation to the broadcasting contents, it is necessary to make a consent agreement relating to the re-use of the broadcasting contents. If it is possible to make the consent agreement with the broadcasting undertaker and/or the information supplier, the chargeable supply of the broadcasting contents comes to be effective. If it is impossible to reach to the consent agreement with the broadcasting undertaker and/or the information supplier, the device or mechanism shown in FIG. 3 may be possible to be applied to. In a case where the consent is made with the undertaker A 16 while not with the undertakers B 17 and C 19, the undertakers B 17 and C 19, with whom the consent cannot be obtained, are asked to prepare files of the broadcasting contents by themselves. And, the present search service center 7 transfers the request for search material to the undertakers B and C, with using a transmitting device 15 for sending and receiving the information between the undertakers of the data broadcastings, and it receives the file of the contents, so as to send (or transmit) them to the viewer. Also, it may be possible to provide information about tendency of the viewers, upon the basis of the search requests made by the viewers, from the search service center to the undertakers, in a form a report.

FIG. 4 shows a mode of the case where the consent cannot be obtained for the re-use of the broadcast contents in the search service center 7, wherein the broadcast contents will not be stored in the data file 22 of the search service center 7, therefore the search service center 7 offers only the good offices in relation to the supply of the broadcast contents 21, 18 and 20 by the broadcasting undertakers A, B and C, respectively.

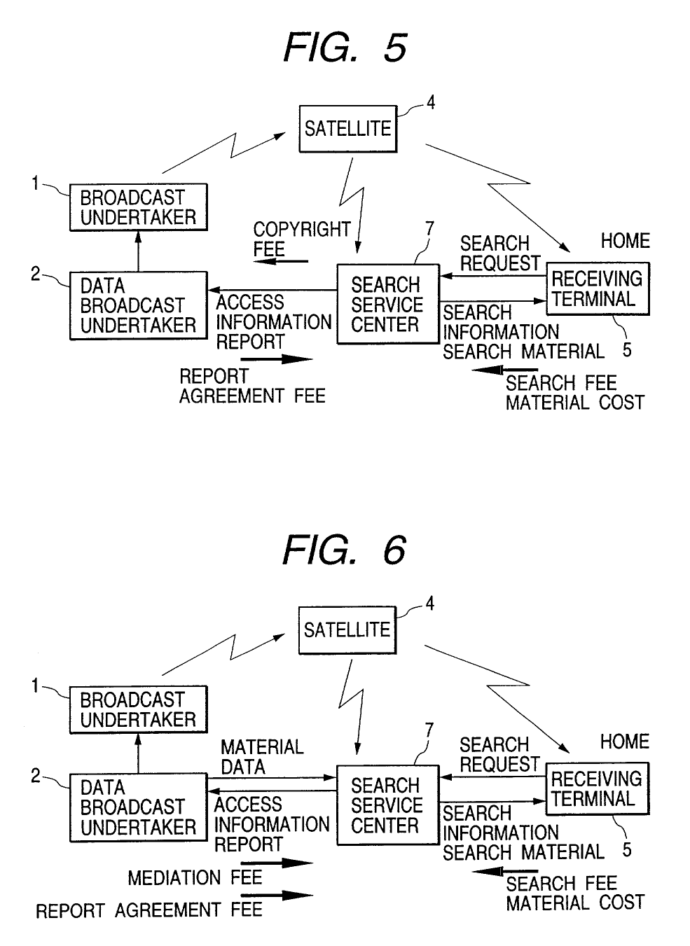

FIG. 5 shows a mode of business of the present search service center 7. Arrows of thin lines indicate the flows of the information and services, while arrows of thick lines the flow of the charges or fees. The search service center 7 provides a search report (or answer) of, such as, a location number of the Internet information, in addition to the EPG information and the location of the data broadcasts, responding to the search request from the receiving terminal 5. Further, when the request is made on the past broadcasting from the receiving terminal 5, the search service center 7 provides the content data. As a consideration for those services, the search service center 7 collects a search fee and/or a cost for search material from the viewer. In this instance, the charge information may be determined so that the cost or fee depends upon the difficulty of the search, the content of the request and an amount of information of the report, thereby to collect the charge. It is very important from a business view point to set a low price for a simple search, so as to activate the use of the present search service. Also, payment must be made for the copyrights to the broadcaster side, for example, the data broadcasting undertaker 2, etc., under the contract of re-use of the contents, however since they are the information that was broadcasted already, the re-use thereof is beneficial to both the data broadcasting undertaker and the provider (or supplier) of the information, therefore, the contract in a form of charge-free or the like can be made. Further, the search service center 7 can also prepare a customer trend information of, such as,a market trend and a taste trend, etc., upon basis of the search requests from the viewers, which are analyzed therein. Accordingly, it can supply the data broadcasting undertakers with said the customer trend information, thereby to obtain a fee for supplying the information or under the contract in relation to the supply of the information. With those information, the charge information may be determined so that the cost is different depending upon the content or an amount of the information, thereby to collect the charge.

Further, it may be possible to collect the charge with using a card number of a credit card which is informed from the user or an account number of banking institution.

Also, FIG. 6 shows a flow of the charge when the consent cannot be obtained on the re-use of the broadcasting data. Though the material cost paid by the viewer is delivered to the data broadcasting undertaker, the search service center can receive a portion of the material cost as a mediation fee, in the mediation service for an aid of the re-use of the broadcasting content data of the data broadcasting undertaker 2.

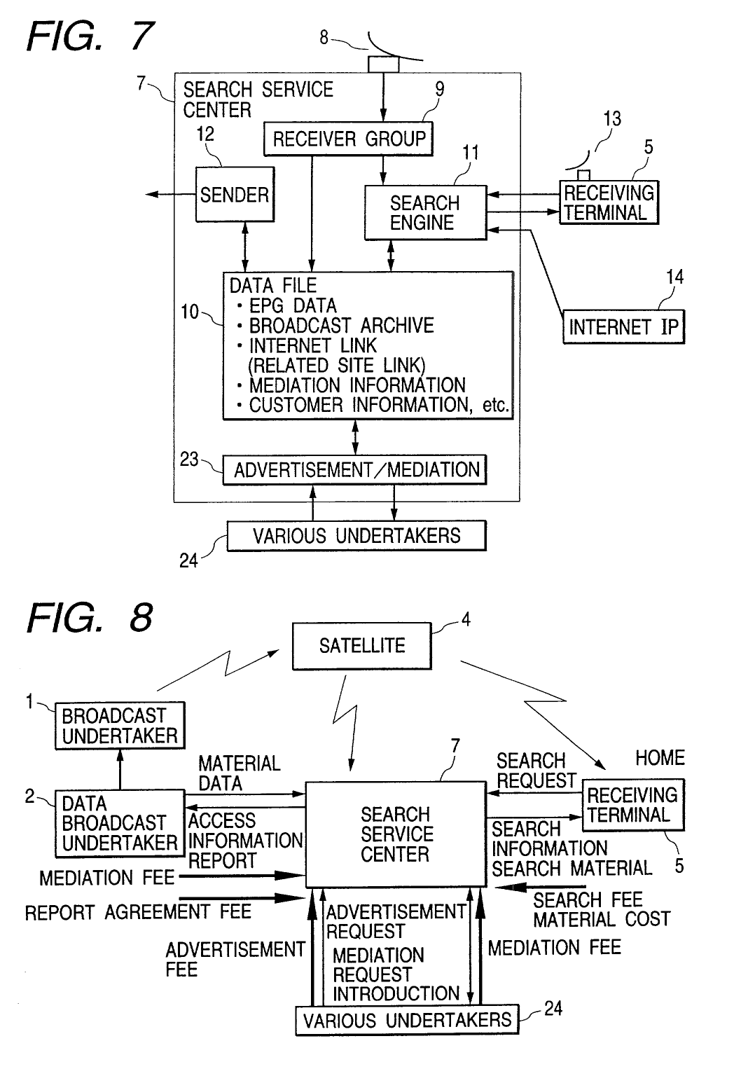

FIG. 7 shows further other mode of the present search service center 7. In this FIG. 7, a window 23 for service of advertisement and/or mediation is newly provided in the present search service center 7. The window 23 for advertising and/or mediation service accepts a request for advertisement and/or an introduction of business, and registers them into the data file. The data file 10 introduces the advisements of the various undertakes 24 and/or the business location or address and the business content thereof, relating to the search report information, when the search report information is supplied to the viewer.

FIG. 8 shows a flow of the charge in the further other mode of the present search service center 7 shown in the FIG. 7. The search service center 7 can obtain the advertisement fee and the mediation fee from each of the various undertakers 24, as a consideration for the services of advertisement and/or mediation thereof. The fees can be determined to be uniform or depending upon the contents of the services, however it may be logical to be a combination between a uniform fee for registration and the fees proportional to the number of the introductions made.

The supply of the data screen materials to the viewers, in relation to the advertisement and/or mediation, must be conducted under the consent of the data broadcast undertakers 2 and/or the supplier of information. On a while, when it is not necessary to supply the data screen materials relating to the advertisement and/or the mediation, this consent is not necessary, and then, the search service center supplies the viewers with the location information of the data broadcasting and/or the location information of the related information thereof on the Internet, etc. Also, if the search service center produces a market report on the viewer's tendency of taste from the access data made by the viewers, so as to supply it to the broadcast undertakers and related ones at the charge, they can put it to practical use, for example, for determining an increase in the number of popular programs, or re-broadcasting of the programs which are broadcasted once and/or the number of re-broadcast thereof, by referring to the market report. In the present system, it is possible to obtain the search fee from the viewers, the service fee relating to the advertisement and mediation from the various undertakers, and subscriber fee of the market report from the broadcast undertakers and the related ones. Herein, an important point of this business is to increase up the accesses from the viewers, therefore it is preferable to suppress the search fee from the viewers to be a free-charge or a low-charge, to promote the use by the viewer, thereby activating the businesses in the service relating to the advertisement and mediation and the subscribing of the market report, etc.

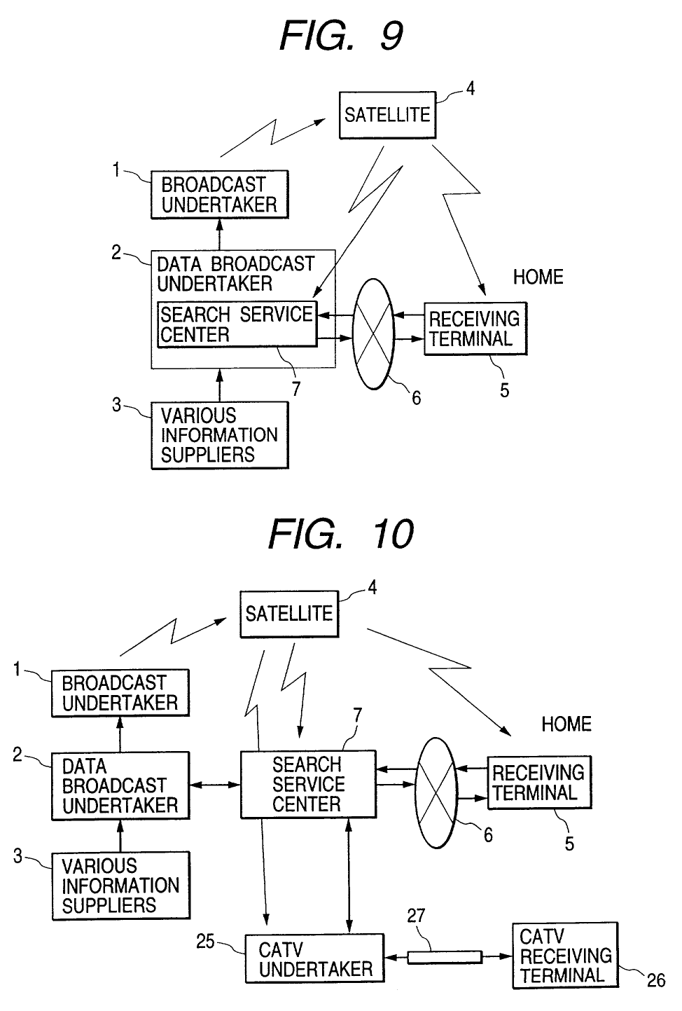

However, the search service center 7 mentioned heretofore is explained, so that it can run as an independent business in the BS broadcasting system mentioned above. However, it should not be restricted only to this, and it can run also as a part of an organization of the data broadcast undertaker 2, as shown in FIG. 9.

Then, heretofore, the explanation was given on the case where the broadcast is received directly from the satellite in the present search service, however, explanation will be given on a case where the broadcast is received and transmitted again in the present search service system, i.e., the CATV system is used therein, hereinafter. In this case, the undertaker of the CATV supplies the viewers with the program services of, such as, the programs of satellite broadcasting received, the programs of broadcast by ground wave, and the program services which are edited or produced independently by itself. In the case of the CATV, the EPG must be re-formed, but in the case of the data broadcasting, it can be supplied as it is, while the data broadcasting can be received by the receiving terminal at home, which has the same device or mechanism to that for use of the satellite one. The same problem will occurs in each home joining to the CATV, as in the receiving of the satellite broadcasting, therefore the present search service is still effective thereto.

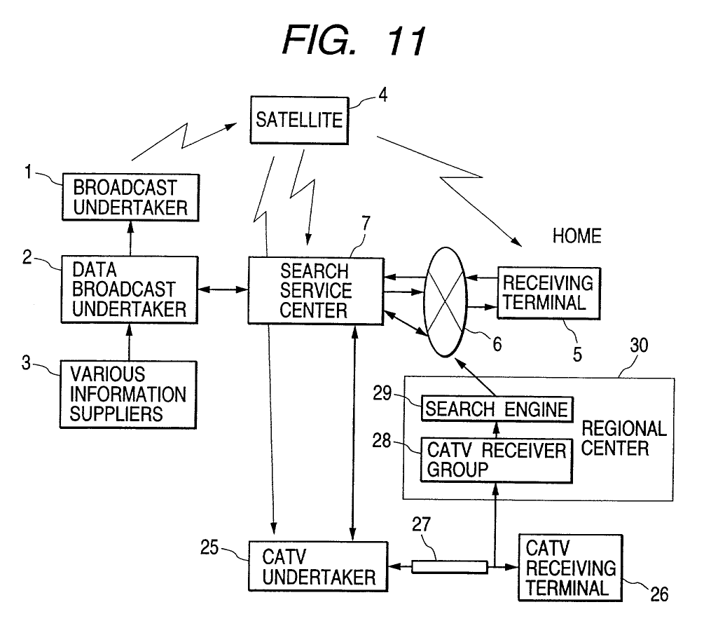

FIG. 10 shows a relationship between the search service center 7 and the CATV undertaker 25. In the case of the CATV system, the search request from the receiving terminal 26 at home reaches to the CATV undertaker 25 through a bidirectional cable 27. Accordingly, if the EPG information and the data broadcast information, which is received by the present search service center 7, are supplied to the CATV undertaker 25, the CATV undertaker 25 can meet demand from the viewers. In this instance, the search service center 7 can obtain an income from the supply of the information to the CATV undertaker 25.

In the case of the CATV, there exists an original or unique information supply service, i.e., supplying the information closely relating to an area or region. If this original information is inserted into the data area of an original program, so as to be supplied, in the form of the screen image, which can be displayed by the BML and XML in the same manner of the satellite broadcasting, then a new business can be started and developed as a CATV station.

FIG. 11 shows a search system unique to the CATV. In the service area of the CATV, a regional center 30 is disposed, which has a group of CATV receivers 28 and a search engine 29, and the search information unique to the CATV is sent out (or transmit) to the search service center 7 through the telephone circuit 6, therefore it is possible to supply an appropriate search information to the CATV undertaker. If the content data of the CATV broadcasting is formed by using the content file of the CATV station, the CATV undertaker and the present search service center can exist together, and an advantage is resulted that there is no necessity of a large file in the regional center.

Since the CATV system is dispersed or decentralized in each area or region, the regional center is disposed for each of the areas of the CATV stations, in relation to the original data thereof, so as to connect between the present search service center through a network, such as the Internet, thereby enabling the viewers to use the search for wide area information and the regional one, without the distinction thereof.

Heretofore, the explanation was given on the search service, mainly, however an application to those other than the search service is also important.

As was mentioned previously, the viewers can receive and obtain the EPG for all stations without necessity of the channel selection on the receiving terminal, however they cannot receive and obtain the EPG for each station unless they select that channel on the receiving terminal. Then, the EPG for all stations and the EPGs for each station, which are received and collected in the present search service center, are hierarchically combined in a form so that they can be seen collectively, to be supplied through a certain data broadcasting channel, then the convenience or usability for the viewer is improved greatly. The characteristic of this service lies in, not only that the EPG for all stations and then EPGs for each station are combined together, but also that a service guide for the data broadcast service of each station is supplied collectively.

If the service mentioned above is provided, together with the device or mechanism explained in the FIG. 2, i.e., the screen for the search service is inserted into the data broadcast, to be supplied to the viewers, while the viewers can send out (or transmit) requests to the search service center from the screen for search service, so as to obtain the search results therefrom, then the convenience or the usability can be improved much more, and the viewers can utilize the search service through the screen.

Explanation will be given on an application in relation to the trend information of the viewers, which was explained in the FIG. 8. In the present application, a method for obtaining the trend information of the viewers will be shown in more details thereof. First, the receiving terminals, each of which can collect a history of receiving and sending (or transmit) of information, are sold, in cooperation with a manufacturer of the receiving terminals, and then audience histories of the viewers are collected from the receiving terminals, automatically with using the telephone network or the Internet network, under the consent of the viewers. By combining the information of general audience rating assumed and the positive audience information obtained in the search service, it is possible to grasp a condition relating to a tendency or trend on interests of the viewers and a rate of depth thereof. The audience history and/or access information of the viewers are the information, which the broadcast undertakers and the service suppliers wish to have, therefore there can be established a business of supplying the information at charge. Further, the present information is an important one also for the viewers, who cannot decide what to see among a mass of the information, therefore it is possible to provide a service of the information about, such as “Top Ten”, etc., which the popular ranking of audience is high and access are concentrated to, to the viewers at charge. On a while, if the audience information mentioned above is supplied to as a program in the form of the data broadcast, a large number of viewers, being interested in the tendency or trend of audience and topics, may view the present information. Therefore, publishing the advertisement on this screen provided is effective, and the broadcasting business can be expected upon an income from the advertisement. In particular, with the data broadcasting service of being sent out (or transmitted) repetitively, since it is possible to supply the program guides and the tendency of audience for the present data broadcasting services, which are extending over all stations, in real time, then especially, the information of the audience ranking of the data broadcasting services on the air comes to be effective. Namely, the viewer can know, take in, and view the data broadcasting service on the topics, from the audience ranking information without missing them, therefore there is a probability of a situation, where the service of supplying the information, such as the audience ranking, etc., is viewed at first.

By combining the EPG service mentioned above, the search service mentioned above, and the viewer information service mentioned above, together, a new business could be established for supplying the information about the data broadcastings.

However, in the embodiments mentioned above, the explanation was given on an assumption of the BS digital broadcasting, but the present invention should not be restricted only to this, and the embodiments mentioned above can be also applied to digital broadcastings, in general, such as the ground wave digital broadcasting and other satellite digital broadcastings, etc.

While we have shown and described several embodiments in accordance with our invention, it should be understood that the disclosed embodiments are susceptible of changes and modifications without departing from the scope of the invention. Therefore, we do not intend to be bound by the details shown and described herein but intend to cover all such changes and modifications falling within the ambit of the appended claims.

What is claimed is:

1. A search system comprising:
a plural number of transmitting apparatuses, each having a transmitting means for transmitting a unique information through a channel for exclusive use thereof;
a receiving apparatus, having a receiving means for receiving the unique information transmitted through a predetermined channel and a search request means for requesting a search on the unique information which is transmitted through a channel other than that predetermined channel; and
a search apparatus, having a receiving means for receiving the unique information transmitted through the respective channels for exclusive use thereof, a storage means for storing the unique information received by said receiving means, a search means for searching the unique information stored in said storage means upon the search request from the search request means of said receiving apparatus, and a transmitting means for transmitting a content which is searched by said search means to said receiving apparatus.

2. A search system, as defined in the claim 1, wherein said receiving apparatus displays a search screen information which is transmitted by said transmitting means, so that the search request can be made by operating the search screen displayed.

3. A search system, as defined in the claim 1, wherein said receiving apparatus has a safekeeping means for safekeeping a history of information which is received, and a transferring means for transferring the histories which are kept in said safekeeping means.

4. A search system, as defined in the claim 1, wherein said unique information includes a guide information on programs, and information about contents of the programs.

5. A search system, as defined in the claim 1, wherein said search apparatus has a charge determining means for determining charge information to be paid depending upon a content which is searched by said search means or an amount thereof.

6. A search system, as defined in the claim 1, wherein said search apparatus has a viewer trend information forming means for forming a viewer trend information, upon basis of the search requests which are requested from said search request means or the histories which are transferred from said transferring means.

7. A receiving apparatus for receiving transmissions from a plural number of transmitting apparatuses, each having a transmitting means for transmitting a unique information through a channel for exclusive use thereof, comprising:
a receiving means for receiving the unique information which is transmitted through a predetermined channel; and
a search request means for making a search request for the unique information which is transmitted through a channel other than the predetermined one.

8. A receiving apparatus, as defined in the claim 7, further comprising:
a display means for displaying a search screen information which is transmitted by said transmitting means, so that the search request can be made by operating the search screen displayed.

9. A receiving apparatus, as defined in the claim 7, further comprising:
a safekeeping means for safekeeping a history of information which is received; and
a transferring means for transferring the histories which are kept in said safekeeping means.

10. A receiving apparatus, as defined in the claim 7, wherein said unique information includes a guide information on programs, and information about contents of the programs.

11. A search apparatus, for receiving transmissions from a plural number of transmitting apparatuses, each having a transmitting means for transmitting a unique information through a channel for exclusive use thereof, and for accepting a search request from a receiving apparatus having a receiving means for receiving the unique information which is transmitted through a predetermined channel and a search request means for making a search request for the unique information which are transmitted through channels other than the predetermined one, comprising:
a receiving means for receiving the unique information which are transmitted through channels for exclusive use thereof;
a storage means for storing the unique information which are received by said receiving means;
a search means for searching the unique information which are stored in said storage means upon a search request from the search request means of said receiving apparatus; and
a transmitting means for transmitting a content which is searched by said search means to said receiving apparatus.

12. A search apparatus, as defined in the claim 11, wherein said unique information includes a guide information on programs, and information about contents of the programs.

13. A search apparatus, as defined in the claim 11, further comprising:
a charge determining means for determining charge information to be paid depending upon a content which is searched by said search means or an amount thereof.

14. A search apparatus, as defined in the claim 11, further comprising:
a viewer trend information forming means for forming a viewer trend information, upon basis of the search requests which are requested from said search request means or the histories which are transferred from said transferring means.

15. A search method, comprising the following steps:
an accepting/starting step for starting a service to a specific user, upon receipt of information relating to the specific user;
a searching step for searching information which are transmitted from a broadcasting station, upon the search request from said specific user; and
a transmitting step for transmitting a content which is searched in said searching step to said specific user.

16. A search method, as defined in the claim 15, wherein the information transmitted from said broadcasting station include a guide information on programs, and information about contents of the programs.

17. A search method, as defined in the claim 15, wherein said information relating to the user include at least either one of an address, a name, an age, an occupation, a telephone number, a mail address, a card number, an account number of bank, a test information, an approval of start of service, and a consent of supplying a history of audience.

18. A search method, as defined in the claim 15, further comprising:
a charge determining step for determining charge information to be paid depending upon a content which is searched in said search step or an amount thereof.

19. A search method, as defined in the claim 15, further comprising:
a viewer trend information forming step for forming a viewer trend information upon basis of the search.
